(19) United States
(12) Patent Application Publication
(10) Pub. No.: US 2018/0178219 A1
(43) Pub. Date: Jun. 28, 2018

(54) Chemistry Kits

(71) Applicant: HepatoChem, Inc., Beverly, MA (US)

(72) Inventor: Marc Bazin, Arlington, MA (US)

(21) Appl. No.: 15/735,929

(22) PCT Filed: Jun. 15, 2016
(86) PCT No.: PCT/US16/37573

§ 371 Date: Dec. 12, 2017

Related U.S. Application Data
(60) Provisional application No. 62/180,467, filed on Jun. 16, 2015.

(51) Int. Cl. B01L 9/06; B01J 19/24

(52) U.S. Cl. CPC B01L 9/06; B01J 19/2445; B01L 2200/023; B01J 2219/00087; B01L 2300/126; B01L 2300/041; B01J 2219/24; B01L 2200/025

(57) ABSTRACT

The invention consists of an assembly of a reaction block a holder that contains arrays of vials. The vials can contain one or more of reagents, catalysts, and solvents for carrying out the series of chemical reactions.

### RELATED APPLICATION

This application claims the benefit of U.S. Provisional Application No. 62/180,467, filed on Jun. 16, 2016. The entire teachings of the above application are incorporated herein by reference.

### BACKGROUND OF THE INVENTION

The synthesis of organic compounds is often a multistep process that necessitates the optimization of each step of the chemical synthesis. To identify the best reaction conditions, chemists need to survey reagents, solvents and/or catalysts. However, there are a very limited number of tools that can be used to quickly investigate a specific chemistry. Current apparatuses for parallel chemistry are designed to handle multiple simultaneous reaction conditions in order to produce multiple organic compounds. Current products are typically reaction blocks that do not contain vials, reagents, solvents and/or catalysts. On the other hand, reagents or catalysts can be sold together as a kit, but they do not include a protocol and they are not packaged in the right amount to be directly used in an experiment. Thus, there is a disconnection between chemistry apparatuses and chemical reagents used in those apparatuses.

### SUMMARY OF THE INVENTION

Described herein is an assembly for conducting a series of chemical reactions. The assembly can include a thermally-conductive reaction block having at least two arrays of wells for holding reaction vessels, a holder for positioning the reaction vessels in the arrays of wells, and instructions on the holder related to carrying out the series of chemical reactions in the reaction vessels. The reaction vessels can hold one or more of reagents, catalysts and solvents for carrying out the series of chemical reactions. The reaction vessels can have different heights and the wells of the arrays can have different depths so that the reaction vessels, when inserted into the wells, present a uniform height at their tops. The holder can denote numbered or lettered positions for the reaction vessels. The reaction block can have two arrays of wells, three arrays of wells, or more. Typically, the holder is formed of lightweight disposable material, such as paper, cardboard, plastic, or resin. In some instances, the reaction block is formed of metal, such as aluminum. In some instances, the wells can have different diameters. The assembly can include a cover coupled to the reaction block. The cover can be coupled to the reaction block with a clip. The cover can hold reaction vessels in the wells of the reaction block.

The invention facilitates the survey of chemical reactions. The assembly can contain a series of experiments with an array of reagents, solvents and/or catalysts. The assembly can be compatible with several sizes of vials for different reaction scales and volumes. The depth of the wells in the reaction block can be designed so that differently-sized reaction vessels present a uniform height at the top. By presenting a uniform height at the top, differently-size reaction vessels can be retained in the reaction block using a cover. Further, the cover can retain the reaction vessels in the reaction block when using a needle to pierce a septum on the reaction vessels, such as when transfer liquids with a liquid handling system. In other words, the cover can prevent the vial from being removed from the reaction block when the needle is removed.

The assembly contains a holder designed to position a set of reaction vessels, such as vials containing reagents and/or solvents, so that the reaction vessels directly align with the reaction block. The vials can contain the right amount of reagents, solvents and/or catalysts, and therefore the assembly requires only limited preparation by the user. Additionally, instructions can be printed on the holder to facilitates the performance of the experiments.

The assembly can be placed on a liquid handling system which can perform the liquid transfer needed to prepare the reaction conditions. In other words, the assembly is compatible with liquid handling systems that can perform the dissolution and transfer of the reagents present in the reaction vessels for the user.

The reaction vessels, such as vials, can contain reagents and also a stirring bar so that the chemical reactions can be conducted in the reaction vessels that are placed in the reaction block.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a front elevated view of one arrangement of an assembly for conducting a series of chemical reactions.

FIG. 2 is a front side view of one arrangement of an assembly for conducting a conducting a series of chemical reactions.

FIG. 3 is an example of a holder for use in an assembly for conducting a conducting a series of chemical reactions.

### DETAILED DESCRIPTION OF THE INVENTION

A description of example embodiments of the invention follows.

An embodiment of the invention consists of an assembly that allows the survey of a type of chemistry. The survey can be performed using a plurality of reagents, catalysts and solvents. The plurality of reagents, solvents and/or catalysts are designed to survey and/or optimize a specific type of chemistry such as amide coupling, cross-coupling palladium chemistry, and others.

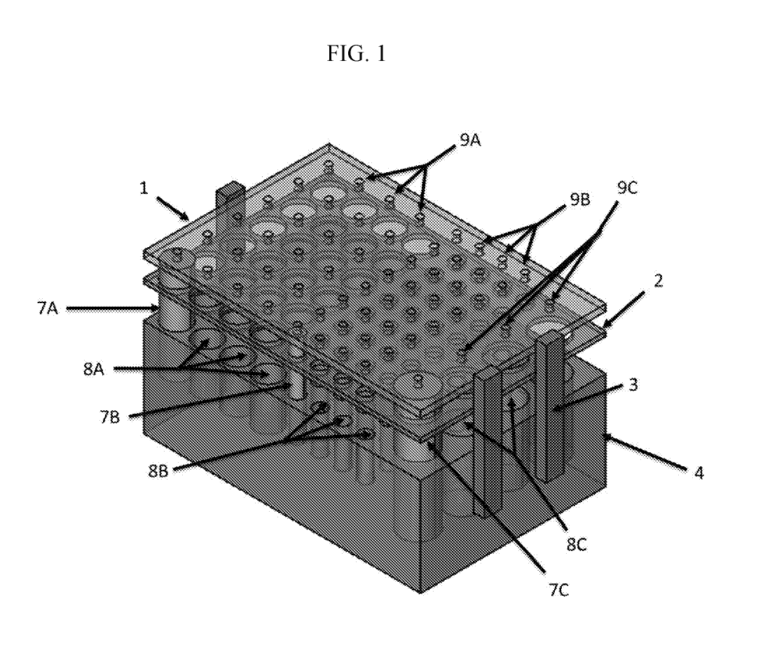

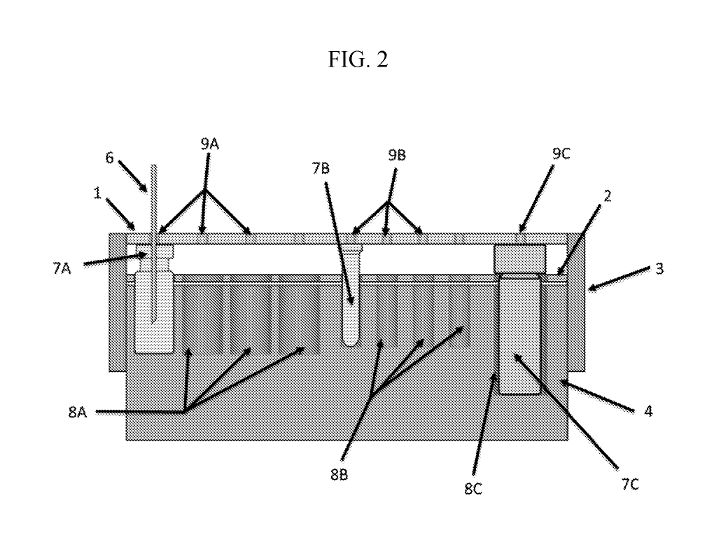

As illustrated in FIGS. 1 and 2, a holder 2 is placed on top of a reaction block 4. Reaction vessels 7A, 7B, and 7C can be placed within the wells 8A, 8B and 8C of the reaction block 4. A cover 1 has openings 9A, 9B and 9C aligned with the wells 8A, 8B and 8C of the reaction block 4. The cover 1 can be maintained on the reaction block 4 using a clip 3, which is attached to the cover and the block. As illustrated in FIG. 2, reaction vessels 7A-C are nested in the wells 8A-C of reaction block 4. A cover 1 can be applied to the top of the reaction vessels 7A-C to maintain the reaction vessels 7A-C within the reaction block 4. The wells 8A-C in the reaction block 4 are designed to allow the top of each reaction vessel 7A-C to present a uniform height, even where the reaction vessels 7A-C have different dimensions. The cover 1 has holes that allow a needle 6 to pierce the septum cap of each reaction vessel 7A-C nested in a well 8A-C of the reaction block 4. The cover 1 can be locked onto the reaction block using a clip 3.

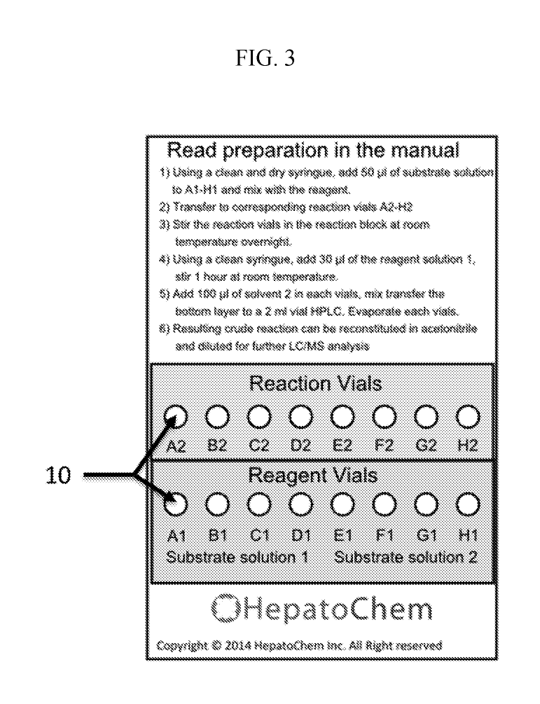

FIG. 3 is an example of a holder 2 that has openings 10 for sixteen reaction vessels (not shown). A protocol is written on the holder 2, and the positions of the openings 10 for the reactions vessels align with the wells 7B of the reaction block 4.

This assembly can contain one or more of reagents, catalysts, and solvents, typically inside the reaction vessels, in exact quantities to perform each individual reaction. The reaction conditions described on the holder 2 are designed to cover a type of chemistry and find an appropriate reaction condition that provides the best conversion to the desired product.

Another embodiment of the invention is a plurality of reaction vessels containing the exact amount of reagents for evaluating a specific chemistry in an array of reaction vessels. Optionally, the precise amounts of solvent necessary to dissolve the substrates can also be included. This plurality of reaction vessels can be packaged with, or optionally within, a holder 2 that fits on top of the reaction block 4. The instructions on holder 2 facilitates the performance of the experiment by describing the successive protocol steps.

Another embodiment of the invention is an assembly of a reaction block that contain up to (24) 6 mm×11 mm vials, up to (32) 8 mm×6 mm vials and up to (4) 4 mm×15 mm vials, a holder that that contain up to (24) 6 mm×11 mm vials, up to (32) 8 mm×6 mm vials and up to (4) 4 mm×15 mm vials and a cover that contains openings that provide access to each opening in the holder and each well in the reaction block.

While this invention has been particularly shown and described with references to example embodiments thereof, it will be understood by those skilled in the art that various changes in form and details may be made therein without departing from the scope of the invention encompassed by the appended claims.

What is claimed is:

1. An assembly for conducting a series of chemical reactions, comprising:
a) a thermally-conductive reaction block comprising at least two arrays of wells for holding reaction vessels for holding one or more of reagents, catalysts, and solvents for carrying out the series of chemical reactions, wherein the reaction vessels have different heights and the wells of the arrays have different depths so that the reaction vessels, when inserted into the wells, present a uniform height at their tops;
b) a holder for positioning the reaction vessels in the arrays of wells;
c) instructions on the holder related to carrying out the series of chemical reactions in the reaction vessels.

2. The assembly of claim 1, wherein the holder denotes numbered or lettered positions for the reaction vessels.

3. The assembly of claim 1, wherein the reaction block has two arrays of wells.

4. The assembly of claim 1, wherein the reaction block has three arrays of wells.

5. The assembly of claim 1, wherein the holder is formed of paper, cardboard, plastic, or resin.

6. The assembly of claim 1, wherein the reaction block is formed of metal.

6. The assembly of claim 6, wherein the reaction block is formed of aluminum.

8. The assembly of claim 1, wherein the wells have different diameters.

9. The assembly of claim 1, further comprising a cover coupled to the reaction block.

10. The assembly of claim 9, wherein the cover is coupled to the reaction block with a clip.

11. The assembly of claim 1, wherein the cover holds reaction vessels in the wells of the reaction block.
